(19) United States
(12) Patent Application Publication
(10) Pub. No.: US 2021/0334200 A1
(43) Pub. Date: Oct. 28, 2021

(54) STORING TRANSLATION LAYER METADATA IN HOST MEMORY BUFFER

(71) Applicant: Micron Technology, Inc., Boise, ID (US)

(72) Inventor: Peng Xu, Milpitas, CA (US)

(21) Appl. No.: 16/855,245

(22) Filed: Apr. 22, 2020

(51) Int. Cl. G06F 12/02; G06F 12/0831; G06F 11/10; G06F 13/42; G06F 13/16; G06F 9/50

(52) U.S. Cl. CPC G06F 12/0246; G06F 12/0833; G06F 11/1004; G06F 2212/7201; G06F 13/1673; G06F 9/5016; G06F 2212/7207; G06F 13/4221

(57) ABSTRACT

An example method of storing translation layer metadata in a host memory buffer comprises: retrieving, from the first memory device, translation layer metadata comprising one or more logical-to-physical (L2P) records, wherein an L2P record of the one or more of L2P records maps a logical block address to a physical address identifying a memory block in the memory system; generating protection metadata for at least a portion of the translation layer metadata; and causing a host system connected to the memory system to store the portion of the translation layer metadata and the protection metadata in a host memory buffer residing on a second memory device of the host system.

### TECHNICAL FIELD

Embodiments of the disclosure relate generally to memory devices, and more specifically, relate to storing translation layer metadata in a host memory buffer.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system operating in accordance with some embodiments of the present disclosure.

FIG. 2 schematically illustrates operations of a memory sub-system storing translation layer metadata in a host memory buffer, in accordance with aspects of the present disclosure.

FIG. 3 schematically illustrates an example layout of the HMB utilized for storing the translation layer metadata, in accordance with aspects of the present disclosure.

FIG. 4 schematically illustrates operations of a memory sub-system retrieving translation layer metadata from a host memory buffer, in accordance with aspects of the present disclosure.

FIG. 5 is a flow diagram of an example method of storing the translation layer metadata in the host memory buffer, in accordance with aspects of the present disclosure.

FIG. 6 is a flow diagram of another example method of storing the translation layer metadata in the host memory buffer, in accordance with aspects of the present disclosure.

FIG. 7 is a flow diagram of an example method of retrieving the translation layer metadata from the host memory buffer for performing a memory access operation, in accordance with aspects of the present disclosure.

FIG. 8 is a block diagram of an example computer system in which embodiments of the present disclosure can operate.

### DETAILED DESCRIPTION

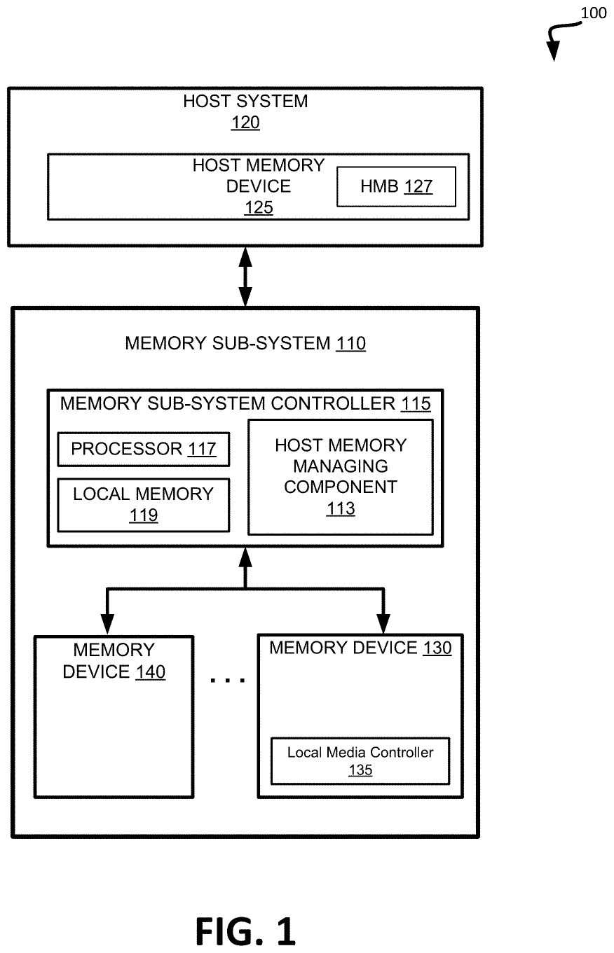

Embodiments of the present disclosure are directed to storing translation layer metadata of a memory sub-system in a host memory buffer. The memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can utilize one or more memory devices, including any combination of the different types of non-volatile memory devices and/or volatile memory devices, to store the data provided by the host system. In some embodiments, non-volatile memory devices can be provided by negative-and (NAND) type flash memory devices. Other examples of non-volatile memory devices are described below in conjunction with FIG. 1. A non-volatile memory device is a package of one or more dice. Each die can consist of one or more planes. Planes can be groups into logic units (LUN). For some types of non-volatile memory devices (e.g., NAND devices), each plane consists of a set of physical blocks. Each block consists of a set of pages. Each page consists of a set of memory cells (“cells”). A cell is an electronic circuit that stores information.

The memory sub-system can perform host-initiated data operations (e.g., write, read, erase, etc.). The host system can send access requests (e.g., write command, read command) to the memory sub-system, such as to store data on a memory device at the memory sub-system and to read data from the memory device on the memory sub-system. The data to be read or written, as specified by a host request, is hereinafter referred to as “host data”. The host system identifies memory blocks by their respective logical block addresses (LBAs), which can be represented by integer numbers of a predetermined size.

In order to isolate from the host system various aspects of physical implementations of memory devices employed by memory sub-systems, the memory sub-system can maintain a data structure that maps each LBA to a corresponding physical address (PA). For example, for flash memory, the physical address can include a channel identifier, a die identifier, a page identifier, a plane identifier and/or a frame identifier. The mapping data structure, which is referred to as a logical-to-physical (L2P) map, can be stored by the memory sub-system on a non-volatile memory device (e.g., a flash memory device).

In order to improve the overall efficiency of data transfers with the host system, some memory sub-systems can cache the L2P on a dynamic random access memory (DRAM) device, which can exhibit access times that are by several orders of magnitude less than access times of non-volatile memory devices. However, in an effort to reduce the cost and/or power consumption, a memory sub-system can be devoid of DRAM. Accordingly, portions of the L2P map of a DRAM-less memory sub-system can be cached on a much smaller static RAM (SRAM) memory device, thus leading to increased latency of random access operations as compared to caching the L2P map on a DRAM device (since only a portion of the L2P map can be cached on a SRAM devices).

In order to reduce the access latency, at least a portion of the L2P map can be stored in a host memory buffer (HMB), which is dedicated by the host for use by the memory sub-system. However, the HMB can be tampered with or corrupted by the host, thus threatening the security and integrity of the flash translation layer.

Aspects of the present disclosure address the above-noted and other deficiencies by providing a protection mechanism for the L2P data stored in the HMB. A memory sub-system operating in accordance with aspects of the present disclosure can manage the L2P data in logical blocks of a predetermined size (e.g., 512 or 4096 bytes) and can attach protection metadata to each logical block before transferring it to the host for storing in the HMB. Upon subsequent retrieval of the logical block from the HMB, the memory sub-system can use the protection metadata to verify integrity of the logical block content.

Therefore, advantages of the systems and methods implemented in accordance with some embodiments of the present disclosure include, but are not limited to, increasing the overall efficiency of data transfers with the host system, while guaranteeing the translation metadata layer integrity.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device (e.g., a processor).

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), etc. The physical host interface can be used to transmit data between the host system 120 and the memory sub-system 110. The host system 120 can further utilize an NVM Express (NVMe) interface to access components (e.g., memory devices 130, 140) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory devices such as 3D cross-point array of non-volatile memory cells and NAND type memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the controller 115, in another embodiment of the present disclosure, a memory sub-system 110 does not include a controller 115, and can instead rely upon external control (e.g., provided by an external host, or by a processor or controller separate from the memory sub-system 110).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

In some implementations, memory sub-system 110 can use a striping scheme, according to which every the data payload (e.g., user data) utilizes multiple dies of the memory devices 130 (e.g., NAND type flash memory devices), such that the payload is distributed through a subset of dies, while the remaining one or more dies are used to store the error correction information (e.g., parity bits). Accordingly, a set of blocks distributed across a set of dies of a memory device using a striping scheme is referred herein to as a “superblock.”

The memory sub-system 110 can also include additional circuitry or components that are not illustrated. In some embodiments, the memory sub-system 110 can include address circuitry (e.g., a row decoder and a column decoder) that can receive an address from the controller 115 and decode the address to access the memory devices 130, 140.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

As noted herein above, the host system 120 identifies memory blocks by their respective logical block addresses (LBAs). In order to isolate from the host system various aspects of physical implementations of memory devices 130, 140 employed by the memory sub-system 110, the memory sub-system 110 can maintain an L2P map that maps each LBA to a corresponding physical address (PA). The L2P map can be stored by the memory sub-system 110 on a non-volatile memory device 130.

In order to improve the overall efficiency of data transfers with the host system, some memory sub-systems can cache the L2P on a dynamic random access memory (DRAM) device, if such a device is present in the memory sub-system. In some embodiments, in an effort to reduce the cost and/or power consumption, a memory sub-system can be devoid of DRAM. In the illustrative example of FIG. 1, the memory sub-system 110 includes one or more non-volatile memory devices 130 (e.g., flash memory devices) and one or more SRAM memory devices 140. Accordingly, the memory sub-system 110 can only cache relatively small portions of the L2P map on one or more SRAM devices 140 (since the whole L2P map, due to it considerably large size, cannot be stored on the SRAM memory devices 140).

In some embodiments, in order to reduce the memory access latency, the memory sub-system 110 can request the host system 120 to allocate a host memory buffer (HMB) 127 residing on the host memory device125 and utilize the HMB 127 for caching relatively large portions of the L2P map. However, the contents of HMB 127 can be tampered with by the host system 120.

Accordingly, for safeguarding the integrity of the L2P data stored in the HMB 127, the memory sub-system 110 can attach protection metadata to each logical block of the L2P data before transferring the logical block it to the host system 120 for storing in the HMB 127. Upon retrieval the logical block from the HMB 127, the memory-subsystem 110 can verify the protection metadata stored with the block, thus detecting any potential tampering with block while it was stored in the HMB 127. Handling the data transfers between the memory devices 130, 140 and the HMB 127 can be performed by the HMB managing component 113, the functions of which can, in various embodiments, be performed by the memory sub-system controller 115 and/or by the local media controller 135 of the memory device 130. For example, the memory sub-system controller 115 can include a processor (processing device) 117 configured to execute instructions stored in local memory 119 for performing the operations described herein. Further details with regards to the operations of the HMB managing component 113 are described below.

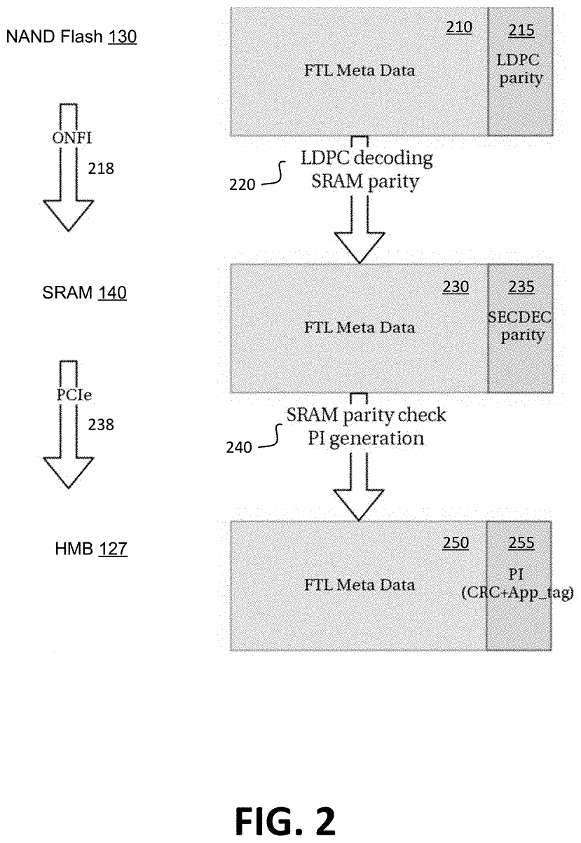

FIG. 2 schematically illustrates operations of a memory sub-system storing translation layer metadata in a host memory buffer, in accordance with aspects of the present disclosure. Upon the memory sub-system power-up, the memory sub-system controller 115 of FIG. 1 can request the host system 120 of FIG. 1 to allocate an HMB 127 residing on the host memory device 125 (e.g., a DRAM memory device). During operation, the memory sub-system controller 115 generates translation layer metadata (e.g., an L2P table) 210, which can initially be stored on a non-volatile memory device (e.g., a flash memory device) 130. Similarly to other data stored on the non-volatile memory device 130, the translation layer metadata can be stored in association with low-density parity-check (LDPC) parity 215.

Upon retrieving (via the Open NANA Flash Interface (ONFI) 218) and decoding (operation 220) at least part of the translation layer metadata 210 (e.g., comprising one or more L2P records) stored on the non-volatile memory device 130, the memory sub-system controller 115 can cache at least a portion 230 of the retrieved translation layer metadata 210 on a volatile memory device (e.g., SRAM memory device) 140. Similarly to other data stored on the volatile memory device 140, the translation layer metadata can be stored in association with a single error correction double error code (SECDEC) parity 235.

The HMB managing component 113 can retrieve and decode the translation layer metadata 230 stored on the volatile memory device 140. At least part of the translation layer metadata 250 can then be cached in the HMB 127 on a volatile memory device (e.g., SRAM memory device) 140, which can be accessed, via the PCIExpress (PCIe) interface 228. Depending on the size of the HMB 127, a portion of the L2P table or an entire L2P table can be stored in the HMB 127.

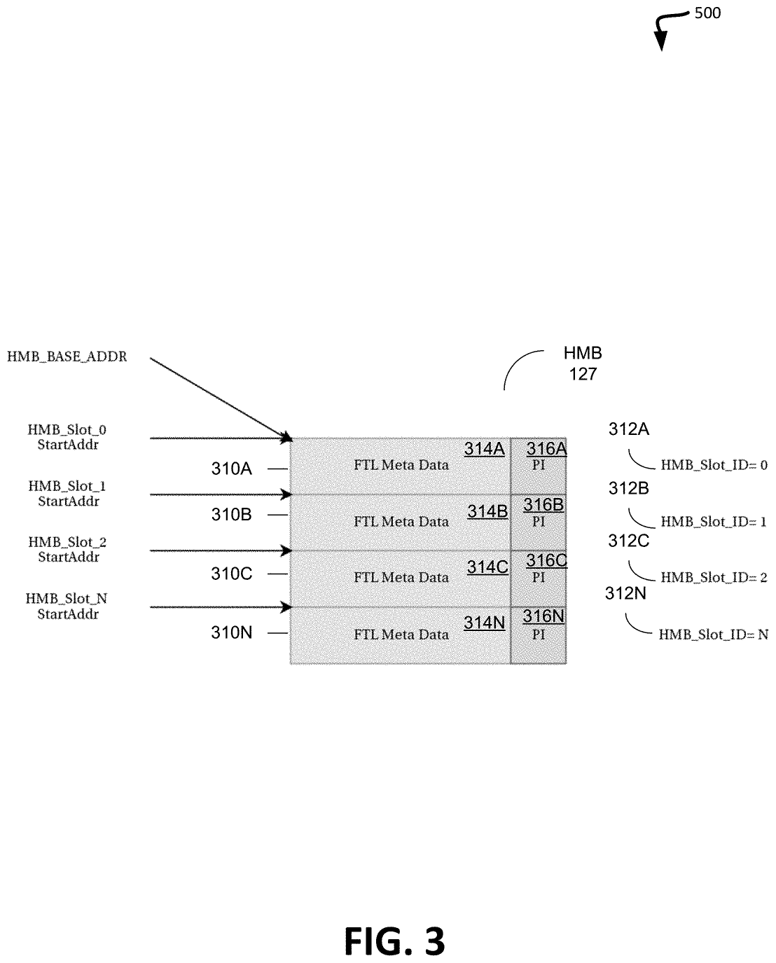

FIG. 3 schematically illustrates an example layout of the HMB utilized for storing the translation layer metadata, in accordance with aspects of the present disclosure. As schematically illustrated by FIG. 3, the HMB managing component 113 can manage the L2P data stored in the HMB 127 in logical blocks of a predetermined size (e.g., 512 or 4096 bytes). Each logical block (also referred to as “HMB slot”) 310A-310N can be referenced by a corresponding HMB Slot Identifier 312A-312N and can store a portion of the translation layer metadata (e.g., including one or more L2P records) 314A-314N.

Before storing the translation layer metadata 250 in the HMB 127, the HMB managing component 113 can attach, to each logical block 310A-310N that is being transferred to the HMB, protection metadata 316A-316N generated in accordance with a protection information (PI) scheme. The PI metadata can include an application tag field and a guard tag field. The application tag field can represent an identifier of the logical block. The guard tag filed can store a cyclic redundancy check (CRC) parity bit for the contents of the logical block. In other implementations, various additional fields can be included into the PI metadata.

In some implementations, in order to implement storing the translation layer metadata to the HMB 127 and/or loading the translation layer metadata from the HMB 127, the memory sub-system 110 can access the host system via the PCIe interface and implement the Non-Volatile Memory express (NVMe) read and/or write command.

The physical memory locations in the host memory to use for storing and/or loading the protection layer metadata data transfers are specified using Physical Region Page (PRP) fields of the read/write command. Each command can include two PRP entries. The first PRP entry, PRP1, can specify the starting address of the HMB slot 310 to be stored/loaded, and the second PRP entry, PRP2, can specify the ending address of the HMB slot 310 to be stored/loaded.

The application tag of the command can specify the identifier of the HMB slot 310.

The reference tag of the command can be used to specify the version number.

The LB count field of the command can be set to zero, unless multiple HMB slots are retrieved simultaneously. In the latter case, the memory sub-system 110 can specify a pointer to a PRP list that describes a list of PRP entries.

The Protection Information Action (PRACT) field, which indicates the action to take with respect to the protection information, can be set to “1” for the write (store) command, thus causing the protection information to be stored in the HMB along with the translation layer metadata. For the read (load) command, the PRACT field can be set to “0”, thus causing the protection information to be stripped out from the translation layer metadata retrieved from the HMB.

The Protection Information Check (PRCHK) field, which indicates the fields to be checked as part of end-to-end data protection processing, can be set to “0” for the write (store) command, since the protection information will be inserted when the translation layer metadata is transferred from the memory sub-system to the HMB. For the read (load) command, the PRACT field can be set to “1”, thus causing the protection information to be checked when the translation layer metadata is transferred from the HMB to the memory sub-system.

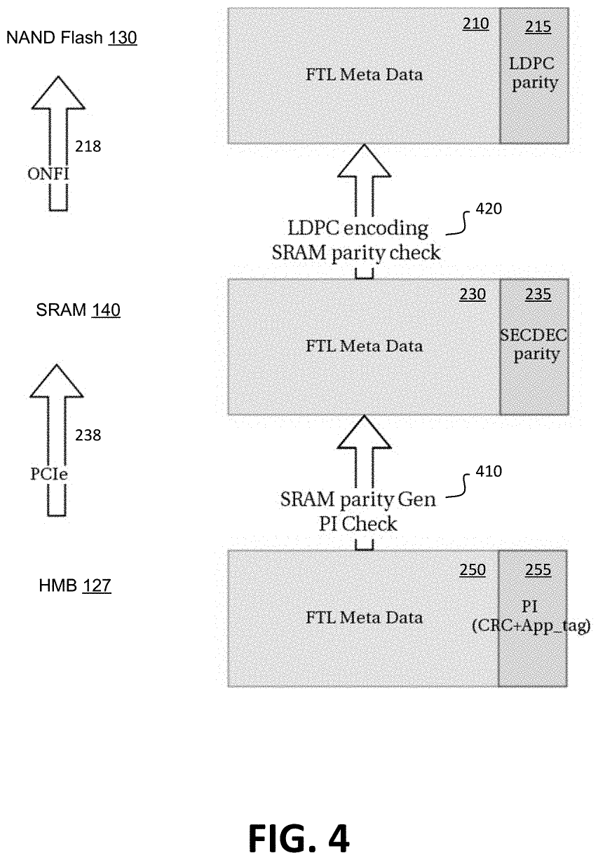

FIG. 4 schematically illustrates operations of a memory sub-system retrieving translation layer metadata from a host memory buffer, in accordance with aspects of the present disclosure. When the memory sub-system 110 requires at least a portion of the translation layer metadata which is stored in the HMB 127 (e.g., responsive to receiving a read or write request), the HMB managing component 113 can retrieve, via the PCIExpress (PCIe) interface 228, at least part of the translation layer metadata 250 stored in the HMB 227. Upon retrieval of each logical block stored in the HMB 127, the HMB managing component 113 can use the protection metadata 255 to verify integrity of the retrieved translation layer metadata. In an illustrative example, the HMB managing component 113 can compute the CRC parity of the translation layer metadata and compare the computed value to the CRC value stored by the protection metadata 255. Should the two values fail to match, the corresponding metadata block retrieved from the HMB 127 should be discarded.

Otherwise, if the computed CRC parity of the translation layer metadata retrieved from the HMB 127 matches the CRC value stored by the protection metadata 255, the HMB managing component 113 can cache at least part 230 of the retrieved translation layer metadata 255 on the SRAM device 238, which can be accessed, e.g., via the PCIExpress (PCIe) interface 228. Similarly to other data stored on the volatile memory device 140, the translation layer metadata can be stored in association with a single error correction double error code (SECDEC) parity 235. The memory sub-system controller 115 can utilize the retrieved translation layer metadata for servicing one or more memory access requests.

Furthermore, if the translation layer metadata is modified by the memory sub-system controller 115, it can be stored on a non-volatile memory device (e.g., a flash memory device) 130. Similarly to other data stored on the non-volatile memory device 130, the translation layer metadata can be stored in association with low-density parity-check (LDPC) parity 215.

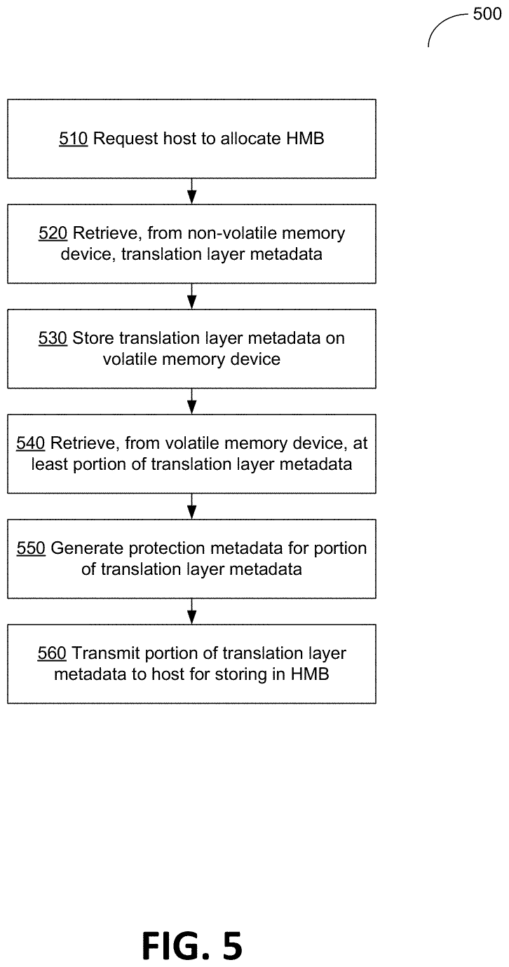

FIG. 5 is a flow diagram of an example method of storing the translation layer metadata in the host memory buffer, in accordance with aspects of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the HMB management component 113 of FIG. 1. As noted herein above, the functions of the HMB management component 113 may be performed by the memory sub-system controller 115 or by the local media controller 135 of FIG. 1. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 510, the processing device implementing the method requests the host system to allocate an HMB residing on a non-volatile memory device (e.g., DRAM memory device) of the host system. The request can specify the HMB size.

At operation 520, the processing device retrieves, from a non-volatile memory device (e.g., flash memory device) of the memory sub-system, translation layer metadata including one or more L2P records. Each L2P record maps a logical block address to a physical address identifying a memory block in the memory sub-system, as described in more detail herein above.

At operation 530, the processing device stores the retrieved translation layer metadata on a volatile memory device (e.g., SRAM memory device) of the memory sub-system;

At operation 540, the processing device retrieves, from the volatile memory device, at least a portion of the translation layer metadata.

At operation 550, the processing device generates protection metadata for the portion of the translation layer metadata. The protection metadata can include an application tag field and a guard tag field. The application tag field can represent an identifier of the logical block of the translation layer metadata. The guard tag filed can store a cyclic redundancy check (CRC) parity bit for the contents of the logical block, as described in more detail herein above.

At operation 560, the processing device transmits the portion of the translation layer metadata, together with the associated protection metadata, to the host system for storing in the HMB, and the method terminates.

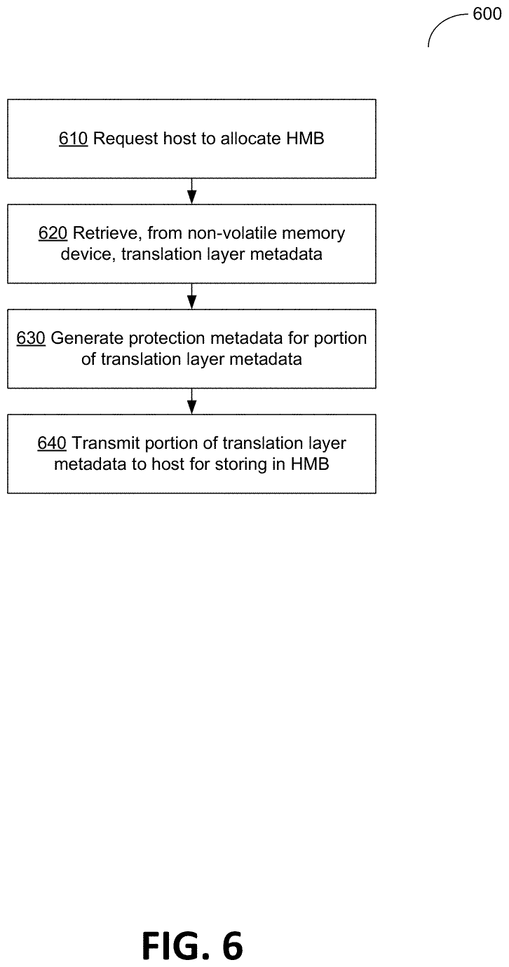

FIG. 6 is a flow diagram of another example method of storing the translation layer metadata in the host memory buffer, in accordance with aspects of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the HMB management component 113 of FIG. 1. As noted herein above, the functions of the HMB management component 113 may be performed by the memory sub-system controller 116 or by the local media controller 136 of FIG. 1. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 610, the processing device implementing the method requests the host system to allocate an HMB residing on a non-volatile memory device (e.g., DRAM memory device) of the host system. The request can specify the HMB size.

At operation 620, the processing device retrieves, from a non-volatile memory device (e.g., flash memory device) of the memory sub-system, translation layer metadata including one or more L2P records. Each L2P record maps a logical block address to a physical address identifying a memory block in the memory sub-system, as described in more detail herein above.

At operation 630, the processing device generates protection metadata for the translation layer metadata. The protection metadata can include an application tag field and a guard tag field. The application tag field can represent an identifier of the logical block of the translation layer metadata. The guard tag filed can store a cyclic redundancy check (CRC) parity bit for the contents of the logical block, as described in more detail herein above.

At operation 640, the processing device transmits the translation layer metadata, together with the associated protection metadata, to the host system for storing in the HMB, and the method terminates.

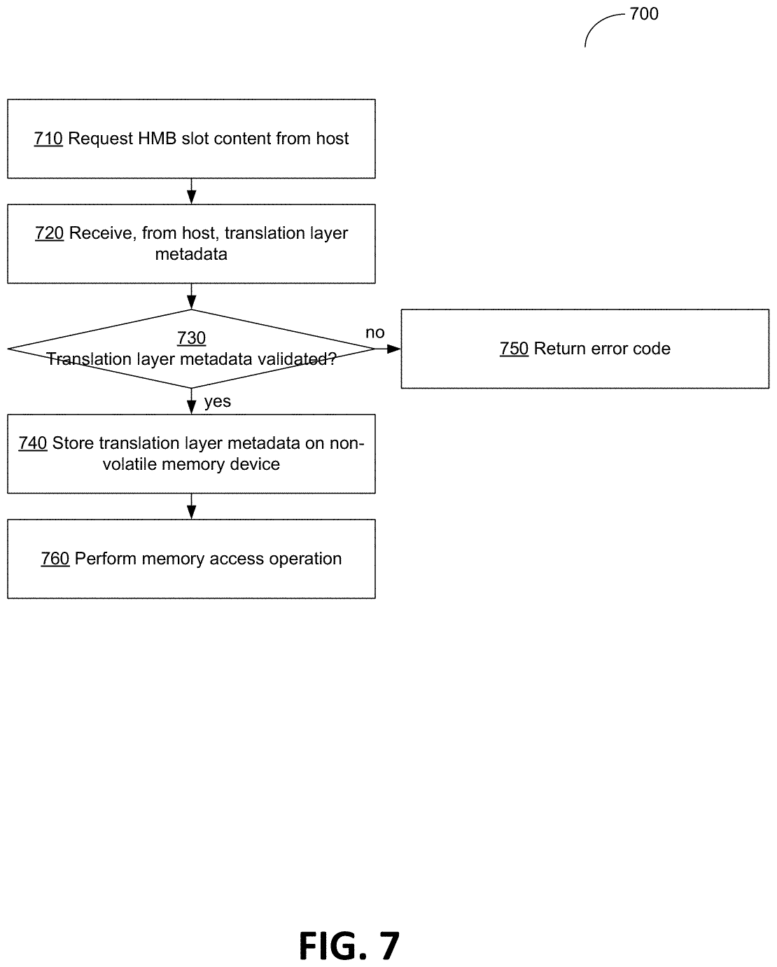

FIG. 7 is a flow diagram of an example method of retrieving the translation layer metadata from the host memory buffer for performing a memory access operation, in accordance with aspects of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the HMB management component 113 of FIG. 1. As noted herein above, the functions of the HMB management component 113 may be performed by the memory sub-system controller 117 or by the local media controller 137 of FIG. 1. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 710, the processing device implementing the method requests, from the host system, the content of a specified slot of the HMB containing translation layer metadata.

At operation 720, the processing device implementing the method receives, from the host system, the specified slot of the HMB containing translation layer metadata translation layer metadata and associated protection metadata. The translation layer metadata includes one or more L2P records, such that each L2P record maps a logical block address to a physical address identifying a memory block in the memory sub-system, as described in more detail herein above.

Responsive to successfully validating, at operation 730, the translation layer metadata, the processing device may, at operation 740, store the translation layer metadata on a volatile memory device of the memory system. Validating the translation layer metadata may involve computing the CRC parity of the translation layer metadata and compare the computed value to the CRC value stored by the protection metadata. Should the two values fail to match, the corresponding metadata block retrieved from the HMB is discarded, an exception is thrown at operation 750, and a corresponding error code is returned. Otherwise, if the computed CRC parity of the translation layer metadata retrieved from the HMB matches the CRC value stored by the protection metadata, the processing continues at operation 760.

At operation 760, the processing device utilizes the translation layer metadata for performing a memory access operation (e.g., a read or write operation with respect to a memory location identified by the physical address specified by one or more L2P records contained by the translation layer metadata), and the method terminates.

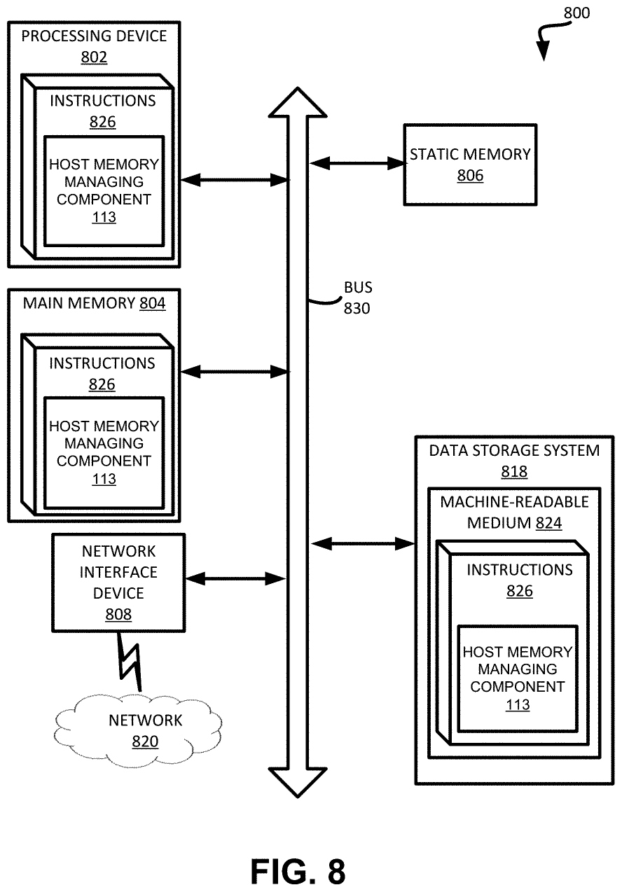

FIG. 8 illustrates an example machine of a computer system 800 within which a set of instructions, for causing the machine to perform any one or more of the methodologies discussed herein, can be executed. In some embodiments, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the HMB managing component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or RDRAM, etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1.

In one embodiment, the instructions 826 include instructions to implement functionality corresponding to a read and write voltage managing component (e.g., the HMB managing component 113 of FIG. 1). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein.

This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory system, comprising:
a first memory device; and
a processing device, operatively coupled to the first memory device, the processing device to perform operations comprising:
retrieving, from the first memory device, translation layer metadata comprising one or more logical-to-physical (L2P) records, wherein an L2P record of the one or more of L2P records maps a logical block address to a physical address identifying a memory block in the memory system;
generating protection metadata for at least a portion of the translation layer metadata; and
causing a host system connected to the memory system to store the portion of the translation layer metadata and the protection metadata in a host memory buffer residing on a second memory device of the host system.

2. The system of claim 1, wherein the first memory device is a non-volatile memory device.

3. The system of claim 1, wherein the second memory device is a volatile memory device.

4. The system of claim 1, wherein the generating the protection metadata further comprises:
computing a cyclic redundancy check value for the portion of the translation layer metadata.

5. The system of claim 1, wherein the operations further comprise:
requesting the host system to allocate the host memory buffer of a specified size.

7. The system of claim 1, wherein the operations further comprise:
receiving, from the host system, the portion of the translation layer metadata and the protection metadata;
responsive to successfully validating, based on the protection metadata, the portion of the translation layer metadata, utilizing the portion of the translation layer metadata for performing a memory access operation.

7. The system of claim 7, wherein the operations further comprise:
responsive to modifying the translation layer metadata, storing the translation layer metadata on a non-volatile memory device of the memory system.

8. A method comprising:
receiving, by a processing device of a memory system, from the host system, translation layer metadata and associated protection metadata, wherein the translation layer metadata comprises one or more logical-to-physical (L2P) records, wherein an L2P record of the one or more of L2P records maps a logical block address to a physical address identifying a memory block in the memory system;
validating, using the associated protection metadata, the translation layer metadata; and
utilizing the translation layer metadata for performing a memory access operation.

9. The method of claim 8, further comprising:
responsive to validating the translation layer metadata, storing the translation layer metadata on a volatile memory device of the memory system.

10. The method of claim 8, further comprising:
responsive to modifying the translation layer metadata, storing the translation layer metadata on a non-volatile memory device of the memory system.

11. The method of claim 8, wherein validating the translation layer metadata further comprises:
computing a cyclic redundancy check value for the translation layer metadata.

12. The method of claim 8, further comprising:
retrieving the translation layer metadata from a non-volatile memory device of the memory system;
generating the associated protection metadata for at least a portion of the translation layer metadata; and
causing the host system to store the portion of the translation layer metadata and the associated protection metadata in a host memory buffer residing on a volatile memory device of the host system.

13. The method of claim 8, wherein receiving the translation layer metadata from the host system is performed via a PCIe interface.

14. The method of claim 8, wherein utilizing the translation layer metadata for performing the memory access operation further comprises:
performing at least one of: a read operation or a write operation with respect to a physical address specified by the translation layer metadata.

15. A method comprising:
retrieving, by a processing device of a memory system, from a non-volatile memory device of the memory system, translation layer metadata comprising one or more logical-to-physical (L2P) records, wherein an L2P record of the one or more of L2P records maps a logical block address to a physical address identifying a memory block in the memory system;
storing the translation layer metadata on a volatile memory device of the memory sub-system;
retrieving, from the volatile memory device, at least a portion of the translation layer metadata;
generating protection metadata for the portion of the translation layer metadata; and
causing a host system connected to the memory system to store the portion of the translation layer metadata and the protection metadata in a host memory buffer residing on a non-volatile memory device of the host system.

17. The method of claim 15, wherein the generating the protection metadata further comprises:
computing a cyclic redundancy check value for the portion of the translation layer metadata.

17. The method of claim 15, further comprising:
requesting the host system to allocate the host memory buffer of a specified host memory buffer size.

18. The method of claim 15, further comprising:
receiving, from the host system, the portion of the translation layer metadata and the protection metadata;
responsive to successfully validating, based on the protection metadata, the portion of the translation layer metadata, utilizing the portion of the translation layer metadata for performing a memory access operation.

19. The method of claim 15, further comprising:
storing the portion of the translation layer metadata on the first memory device.

20. The method of claim 15, wherein receiving the translation layer metadata from the host system is performed via a PCIe interface.
